(19) United States
(12) Patent Application Publication
(10) Pub. No.: US 2024/0193965 A1
(43) Pub. Date: Jun. 13, 2024

(54) ELECTRONIC DEVICE FOR PROVIDING ALARM BY USING DATA ASSOCIATED WITH MOTION INSIDE OF VEHICLE AND METHOD TEHREOF

(71) Applicant: THINKWARE CORPORATION, Seongnam-si (KR)

(72) Inventors: Hyunjin BANG, Seongnam-si (KR); Donghee LIM, Seongnam-si (KR); Taekyu HAN, Seongnam-si (KR)

(73) Assignee: THINKWARE CORPORATION, Seongnam-si (KR)

(21) Appl. No.: 18/532,439

(22) Filed: Dec. 7, 2023

(30) Foreign Application Priority Data
Dec. 9, 2022 (KR) 10-2022-0171376
Nov. 24, 2023 (KR) 10-2023-0165405

(51) Int. Cl. G06V 20/59; G06V 10/82; H04M 1/72436; H04N 7/18

(52) U.S. Cl. CPC G06V 20/59; G06V 10/82; H04M 1/72436; H04N 7/185

(57) ABSTRACT

According to an embodiment, an electronic device may detect states of doors of the vehicle, based on interruption of power received from a battery of a vehicle. The electronic device may, in response to detecting the states corresponding to a closed state, receive sensor data of a plurality of sensors disposed inside the vehicle, through a port. The electronic device may, in response to detecting motion within the vehicle using the sensor data, transmit a signal to provide an alarm associated with the motion, to an external electronic device through a communication circuit.

### CROSS-REFERENCE TO RELATED APPLICATION(S)

This application is based on and claims priority under 35 U.S.C. § 119 to Korean Patent Application No. 10-2022-0171376, filed on Dec. 9, 2022, in the Korean Intellectual Property Office, and Korean Patent Application No. 10-2023-0165405, filed on Nov. 24, 2023, in the Korean Intellectual Property Office, the disclosure of which is incorporated by reference herein in its entirety.

### BACKGROUND

### Technical Field

The disclosure relates to an electronic device for providing an alarm using data associated with motion within a vehicle and a method thereof.

### Description of Related Art

Accidents involving people and/or animals fenced in vehicles are often occurring. To prevent such accidents, monitoring technologies using sensors such as, e.g., infrared sensors are being developed. Sensor data obtained from an infrared sensor may be distorted by the brightness of the vehicle interior and/or light propagated into the vehicle through its windows. The accuracy of detecting people and/or animals using an infrared sensor may be reduced by an obstruction between the person and the infrared sensor.

The above information may be presented as related arts only to assist with an understanding of the disclosure. No determination has been made, and no assertion is made, as to whether any of the aforementioned might be applicable as a prior art with regard to the disclosure.

### SUMMARY

According to an embodiment, an electronic device mountable on a vehicle may be provided. The electronic device may comprise a port, a communication circuit, memory storing instructions, and a processor. The instructions, when executed by the processor, may cause the electronic device to detect states of doors of the vehicle based on interruption of power which was received from a battery of the vehicle. The instructions, when executed by the processor, may cause the electronic device to, in response to detecting the states corresponding to a closed state, receive sensor data of a plurality of sensors disposed inside of the vehicle, through the port. The instructions, when executed by the processor, may cause the electronic device to, in response to detecting motion within the vehicle by using the sensor data, transmit a signal to provide an alarm associated with the motion, to an external electronic device through the communication circuit.

According to an embodiment, a method of an electronic device comprising a port and a communication circuit and mountable on a vehicle may be provided. The method may comprise detecting states of doors of the vehicle, based on interruption of power which was received from a battery of the vehicle. The method may comprise, in response to detecting the states corresponding to a closed state, receiving sensor data of a plurality of sensors disposed inside of the vehicle, through the port. The method may comprise, in response to detecting motion within the vehicle by using the sensor data, transmitting a signal to provide an alarm associated with the motion to an external electronic device through the communication circuit.

According to an embodiment, a non-transitory computer-readable storage medium including instructions may be provided. The instructions, when executed by a processor of an electronic device including a port and a communication circuit, and mountable on a vehicle, may cause the electronic device to detect states of doors of the vehicle based on interruption of power which was received from a battery of the vehicle. The instructions, when executed by the processor, may cause the electronic device to, in response to detecting the states corresponding to a closed state, receive sensor data of a plurality of sensors disposed inside of the vehicle through the port. The instructions, when executed by the processor, may cause the electronic device to, in response to detecting motion within the vehicle by using the sensor data, transmit a signal to provide an alarm associated with the motion to an external electronic device through the communication circuit.

### BRIEF DESCRIPTION OF THE DRAWINGS

FIG. 1 illustrates an embodiment of an electronic device disposed in a vehicle.

FIG. 2 illustrates an example block diagram of an electronic device according to an embodiment.

FIG. 3 illustrates an example flowchart for an operation of an electronic device according to an embodiment.

FIG. 4 illustrates example text messages displayed on a user terminal by a signal transmitted from an electronic device according to an embodiment.

FIG. 5 illustrates exemplary sensors distributed inside a vehicle including an electronic device according to an embodiment.

FIG. 6 illustrates exemplary locations of a plurality of cameras distributed inside a vehicle including an electronic device according to an embodiment.

FIGS. 7A and 7B illustrate exemplary locations of a plurality of radars distributed inside vehicles having different dimensions.

FIG. 8 illustrates an exemplary wired connection between an electronic device and one or more sensors according to an embodiment.

FIG. 9 illustrates an example of information displayed through a display of a vehicle according to an embodiment.

FIG. 10 illustrates an example of a screen displayed on a display of a user terminal according to a signal transmitted from an electronic device according to an embodiment.

FIG. 11 illustrates an example of information related to at least one passenger in a vehicle including an electronic device, detected by the electronic device, according to an embodiment.

### DETAILED DESCRIPTION

Certain structural or functional descriptions of embodiments according to the concepts of the present invention disclosed herein are illustrated only for the purpose of describing embodiments according to the concepts of the invention, and the embodiments according to the concepts of the invention may be practiced in various forms and are not limited to those embodiments described herein.

Embodiments according to the concepts of the present invention may be subject to various modifications and may have various forms, and therefore, the embodiments are illustrated with reference to the attached drawings and described in detail in this specification. However, this is not intended to limit the embodiments disclosed herein to any particular forms of the disclosure and should be construed to include any modifications, equivalents, or substitutions that fall within the scope of the ideas and techniques of the present invention.

Terms such as “first” or “second” may be used to describe various components, but the components should not be limited by such terms. The terms are used solely for the purpose of distinguishing one component from another, e.g., a first component may be named as a second component, and similarly a second component may be named as a first component, without departing from the scope of rights according to the concept of the invention.

When a component is mentioned to be “connected” or “coupled” to another component, it is to be understood that it may be directly connected or coupled to that other component, but there may be other components in between. On the other hand, when a component is mentioned to be “directly connected” or “directly coupled” to another component, it is to be understood that there may be no other components in between. Expressions that describe relationships between components, such as “between” and “immediately between” or “directly adjacent to” are to be construed similarly.

The terms used in this specification are intended to describe specific embodiments only and are not intended to limit the disclosed invention. The singular expression includes the plural unless the context clearly indicates otherwise. Throughout the specification, it is to be understood that the terms “include(s)”, “comprise(s)” or “have/has” and the like are intended to designate the presence of the features, numbers, steps, actions, components, parts, or combinations thereof set forth herein, and are not intended to preclude the possibility of presence or addition of one or more other features, numbers, steps, actions, components, parts, or combinations thereof.

Unless otherwise defined, all terms used herein, including technical or scientific terms, shall have the same meaning as commonly understood by those having ordinary skill in the technical field to which the present invention belongs. Terms such as those defined in commonly used dictionaries are to be construed to have meanings consistent with their contextual meaning in the relevant art and are not to be construed in any idealized or unduly formal sense unless expressly defined herein.

Hereinafter, various embodiments of the disclosure will be described in more detail with reference to the accompanying drawings. However, the scope of this patent application is not intended to be limited or restricted by those embodiments. Same or like reference numerals in each drawing refer to the same or like components or elements.

As the level of automation for vehicles increases and electronic devices mounted on the vehicles become more diverse, new safety standards and/or safety regulations for vehicles are added or enacted by respective national and/or regional legislatures, vehicle safety-related organizations, and the like.

Specifically, as autonomous driving technology for vehicles further advances, the conventional criteria for evaluating the safety standards of a vehicle are expanding from only evaluating the extent that the vehicle protects passengers in the event of an accident, such as in the driving performance test, crash tests, etc. of vehicles, up to including monitoring of potential factors inside the vehicle that may affect the safety of the vehicle in driving, and evaluating the extent that such a monitoring result can prevent any safety-related incidents that might occur in the vehicle.

A system that monitors such an in-vehicle environment may be referred to as an In-Cabin Monitoring System (ICMS).

Typically, the ICMS may include a variety of features depending on what a system is primarily intended to monitor, such as, e.g., a driver monitoring system (DMS) to monitor the driver status (drowsiness, fatigue, distraction, etc.), an occupant monitoring system (OMS) to monitor a state of the vehicle's occupants, a passenger monitoring system (PMS) to mainly monitor passengers other than the driver of the vehicle, and a children monitoring system (CMS) to mainly monitor a status of children in the vehicle.

Currently, for Europe, the European General Safety Regulation, effective from Dec. 13, 2024, mandates that all new cars, vans, trucks, and buses to be sold in the EU territory after the year of 2024 be equipped with ICMS-related technologies, and the EU New Car Asset Program (EU NCAP) also determines the DMS as an important factor of a vehicle's safety rating.

In case of the U.S., the U.S. Congress has enacted a legislation called the “Hot Cars Act” in 2021, which mandates that vehicles be equipped with a system that detects when a passenger is left unattended in a vehicle and requires the vehicle's driver or operator to take safety actions for the unattended passenger.

According to this U.S. Congressional legislation, the U.S. National Highway Traffic Safety Administration (NHTSA) announced new regulations in relation to applying to new passenger vehicles a feature for informing the driver to check the back seat of the vehicle after the vehicle is turned off.

In addition to the Europe and the U.S., several other countries such as Japan, Korea, China and so on are expected to gradually expand the obligation to install ICMS-related features in vehicles.

The present invention has been proposed to meet the requirements resulting from the adoption and mandating of major safety standards for vehicles in each of these countries, and for this purpose, the term “in-vehicle motion detection” as used herein may be used in the same meaning as the term “detection of objects related to safety in a vehicle” which may be included in the ICMS described above.

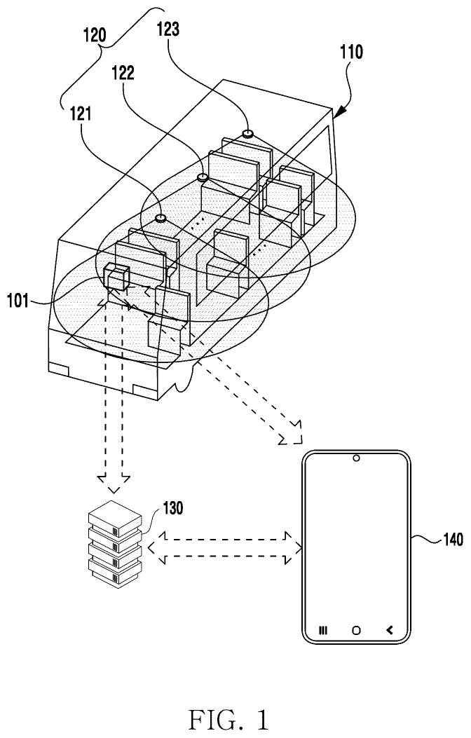

FIG. 1 illustrates one embodiment of an electronic device 101 disposed in a vehicle 110. The electronic device 101 may have a form factor (or exterior, appearance) that is mountable on the vehicle 110. The electronic device 101 may be adhered, fastened, or otherwise secured to an inside of the vehicle 110. For example, the electronic device 101 may include a member (e.g., an adhesive plate) that may be attached to an inner side of a windscreen of the vehicle 110. Embodiments are not limited thereto, and the electronic device 101 may be installed (embedded) in the vehicle 110 as an electronic control unit (ECU). In one embodiment, the electronic device 101 may be configured to generate and/or store video associated with the vehicle 110. The electronic device 101 may be referred to as a dashboard camera, a drive video record system (DVRS), a black-box, and/or a surveillance camera.

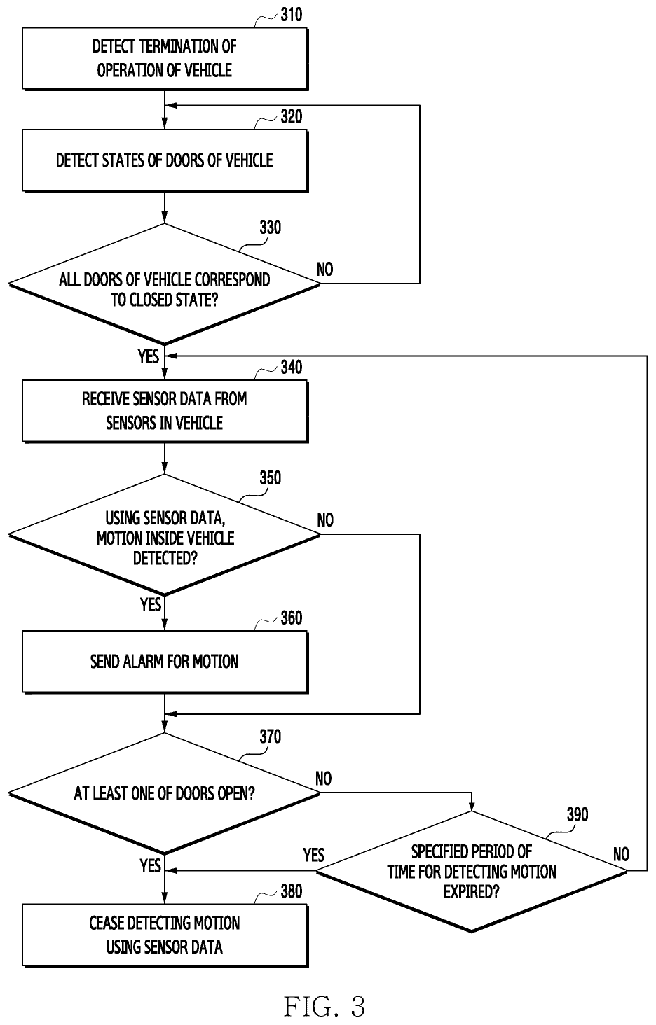

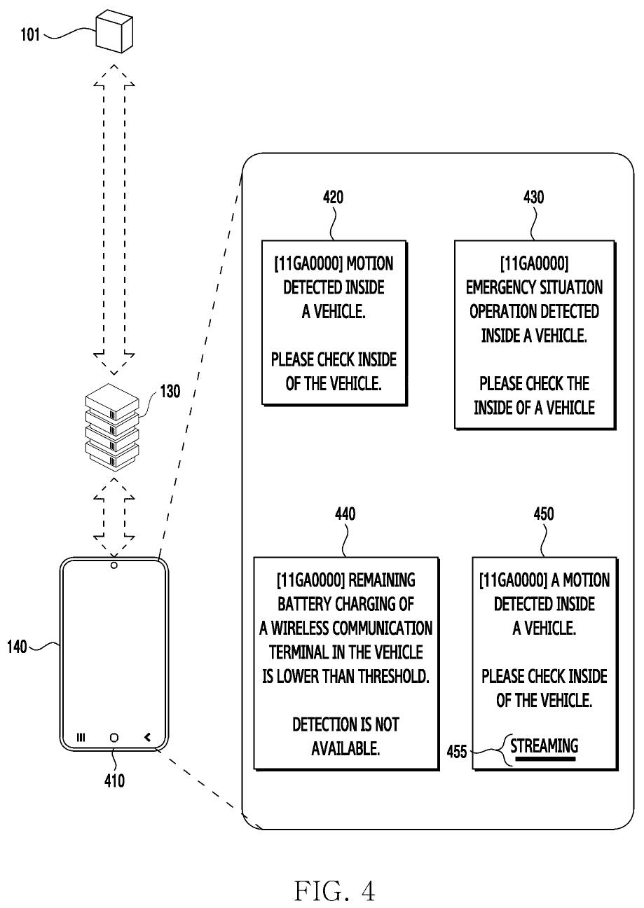

In one embodiment, the electronic device 101 may automatically initiate or perform recording of a camera included in the electronic device 101, in response to detecting an impact. The electronic device 101 that detects motion inside of the vehicle may automatically initiate recording of at least one camera (e.g., cameras connected through a multiplexing device 810) included in the electronic device 101 or connected to the electronic device 101. As will be described below with reference to FIGS. 3 and 4, the electronic device 101 may be a server (e.g., the server 130 of FIGS. 1 through 4) and/or a user terminal (e.g., the user terminal 140 of FIGS. 1 through 4), which may provide an alarm associated with the recording.

Referring to FIG. 1, it is illustrated an exemplary outer appearance of a vehicle 110 having the form of a bus. Embodiments are not limited to thereto, and the vehicle 110 may have various other appearances, such as a sedan, a sport utility vehicle (SUV), and/or a truck. The vehicle 110 may include sensors 120 for obtaining information related to an inner environment and/or an outer environment of the vehicle 110. Referring to FIG. 1, there are shown three sensors (121, 122, 123) disposed at different positions on the vehicle 110, for example. The positions of the sensors disposed on the vehicle 110 are not limited to those of FIG. 1.

According to an embodiment, the electronic device 101 may detect motion generated from an interior of the vehicle 110, using information (e.g., sensor data) obtained from the sensors 120 included in the vehicle 110. For example, the motion may include a motion of a living organism (e.g., a child and/or a pet) trapped in the vehicle 110. When an owner of the vehicle 110 locks the vehicle 110 while the living organism is present in the vehicle 110, a dangerous accident may occur due to suffocation and/or exhaustion of the living organism. According to an embodiment, the electronic device 101 may use the above information to detect any motion in the interior of the vehicle 110, while the doors of the vehicle 110 are unintentionally locked. Upon detecting such a motion, the electronic device 101 may provide an alarm about the motion to an external electronic device (e.g., the server 130 and/or the user terminal or user equipment 140) connected via a wireless network. For example, to prevent such an unexpected accident, the electronic device 101 may transmit an alarm signal to notify the external electronic device of the motion.

To detect a living organism probably trapped in the vehicle 110, the electronic device 101 may operate in a specific state in which the vehicle 110 is locked, or an engine (or motor) of the vehicle 110 is turned off. For example, while the vehicle 110 is travelling, the electronic device 101 may be charged by a batter of the vehicle 110. When the vehicle 110 is turned off, charging of the electronic device 101 by the battery may be interrupted. In response to the interruption of charging, the electronic device 101 may use the charged power to perform a function and/or action for detecting such a living organism possibly trapped in the vehicle 110. For example, in response to executing the function to detect the living being, the electronic device 101 may transmit a signal to the server 130 to inform the user of the execution of the function.

Referring to FIG. 1, illustrated is an embodiment in which the electronic device 101, the server 130, and the user terminal 140 are connected to each other via a network. The electronic device 101, the server 130, and the user terminal 140 may be incorporated into a system (e.g., an accident prevention system) for preventing accidents from occurring in the vehicle 110 in which the electronic device 101 is equipped. Although not shown herein, at least one of a base station, a router, and/or an access point (AP) may be disposed between the electronic device 101, the server 130, and the user terminal 140, as a member of the network. In terms of communicating with external electronic devices over a network, the electronic device 101 may be referred to as a wireless communication terminal. The network connecting the electronic device 101 with the server 130 may be established by the communication standards such as, e.g., Internet, local area network (LAN), wide area network (WAN), Ethernet, long term evolution (LTE), fifth generation (5G) new radio (NR), sixth generation (6G), above-6G, wireless fidelity (WiFi), Zigbee, near field communication (NFC), Bluetooth and/or Bluetooth low-energy (BLE).

In one embodiment, the server 130 configured to communicate with the electronic device 101 may monitor the status of the electronic device 101 and/or control the electronic device 101. For example, the server 130 may control the electronic device 101 to control at least one of the sensors 120 included in the vehicle 110, or obtain sensor data from at least one of the sensors 120.

For example, the electronic device 101 may transmit a signal to the server 130 that includes sensor data detected by the electronic device 101, or detected by at least one of the sensors 120. The information transmitted to the server 130 may include information related to the electronic device 101 and/or the battery of the vehicle 110 (e.g., a charge amount and/or a battery cycle, such as state of charge (SOC)). The information sent to the server 130 may include information related to the electronic device 101. The electronic device 101 may transmit the signal to the server 130 periodically or repeatedly.

In one embodiment, the server 130 may control the electronic device 101 to control at least one of the sensors 120 included in the vehicle 110. For example, the server 130 may request the electronic device 101 to transmit sensor data from at least one of the sensors 120 included in the vehicle 110. In response to the request, the electronic device 101 may transmit sensor data of at least one of the sensors 120 that is responsive to the request to the server 130. For example, upon receiving the request from the server 130, the electronic device 101 may transmit a signal (e.g., a command) to obtain the sensor data, to at least one sensor, among the sensors 120, for detecting states of the doors of the vehicle 110. The sensor data transmitted from the one or more sensors receiving the signal may be transmitted by the electronic device 101 to the server 130 and/or processed by the electronic device 101 itself.

In one embodiment, upon receiving sensor data from the electronic device 101, obtained by the one or more sensors for detecting the states of the doors, the server 130 may use the sensor data to check the states of the doors of the vehicle 110. When all of the doors of the vehicle 110 correspond to a closed state, the server 130 may request the electronic device 101 to execute a motion detection function. The closed state of the doors may mean a state in which the doors are closed, or the doors are secured to the vehicle 110 by an apparatus for fastening the doors and the vehicle 110. The closed state of the door may mean a state in which the door is prevented from being opened by a lock apparatus included with the door, that is, by means of any external force (e.g., a doorknob). The closed state of the door may be referred to as, or may include, a locked state. In another state different from the closed state (e.g., an open state), the door may be opened by an external force. The server 130 may request the electronic device 101 to acquire and/or process sensor data from the sensors for detecting motion in the interior of the vehicle 110. When at least one of the doors of the vehicle 110 corresponds to a state (e.g., an opened state) different from the closed state, the server 130 may request the electronic device 101 to cease the motion detect function.

In one embodiment, the electronic device 101 may receive a request from the server 130 to detect a motion in an interior of the vehicle 110. Upon receiving the request, the electronic device 101 may transmit a signal associated with the request to the sensors 120 in the interior of the vehicle 110 for detecting the motion. The sensor data transmitted from the sensors 120 may be transmitted by the electronic device 101 to the server 130 and/or processed by the electronic device 101. Embodiments are not limited thereto and the electronic device 101 may receive a signal associated with occurrence of an emergency situation from an emergency control means (e.g., an emergency bell and/or emergency button) in the interior of the vehicle 110. Upon receiving the signal, the electronic device 101 may transmit the signal associated with the emergency situation to the server 130.

As described above, an operation of the electronic device 101 based on a request from the server 130 has been described, but embodiments are not limited thereto. For example, the electronic device 101 may obtain sensor data from the sensors 120 and/or perform functions and/or actions related to the sensor data, without the server 130. For example, the electronic device 101 may detect a motion inside of the vehicle 110, or detect a closed state of the doors, by comparing the sensor data with specified conditions. For example, without communicating with the server 130, the electronic device 101 may receive a signal associated with such an emergency situation from an emergency control means of the vehicle 110, and may use the signal to recognize occurrence of the emergency situation. For example, the electronic device 101 may be implemented as a stand-alone device independent of the server 130. By utilizing the electronic device 101 to operate independently of the server 130, resources and/or operating expense of the server 130 may be reduced.

In one embodiment, the electronic device 101 that detected a motion in the interior of the vehicle 110 may transmit, to the user terminal 140, a notification message related to a result of detecting the motion. The electronic device 101 that detected the motion in the interior of the vehicle 110 may transmit, to the server 130, a signal to provide an alarm associated with the motion. Embodiments are not limited thereto, and the server 130 may use sensor data from the sensors 120, obtained via the electronic device 101, to directly detect the motion inside of the vehicle 110. Upon detecting a motion inside of the vehicle 110, or upon receiving a signal indicating detection of a motion from the electronic device 101, the server 130 may send a notification message to the user terminal 140. The notification message may be provided, for example, in at least one of the following types: short message service (SMS), long message service (LMS), multimedia message service (MMS), push message (or push notification), email, and/or outgoing call. Embodiments are not limited thereto.

The user terminal 140 may include a device with a display (or touchscreen), such as e.g., a mobile phone, smartphone, personal digital assistant (PDA), portable multimedia player (PMP), tablet PC, smart watch, and/or head-mounted device (HMD). The user terminal 140 may include a handheld-based wireless communication device. Embodiments are not limited thereto and the user terminal 140 may include, for example, a desktop personal computer (PC), a tablet PC, a laptop PC, a gaming console, and/or a set-top box (STB) for controlling a television. The user terminal 140 may include electronic components (e.g., a central processing unit (CPU), memory, and/or a display) for installing and/or executing a software application (hereinafter, referred to as an application). For example, an application may be installed, on the user terminal 140, for providing services to detect a motion and/or prevent an accident that may occur in an interior of the vehicle 110. By executing the application, the user terminal 140 may output alarms associated with, for example, a location of the vehicle 110, a result of detecting any motion inside the vehicle 110, a state of a battery of the electronic device 101 (e.g., the amount of charging such as SOC), and/or an emergency situation detected by the emergency control means.

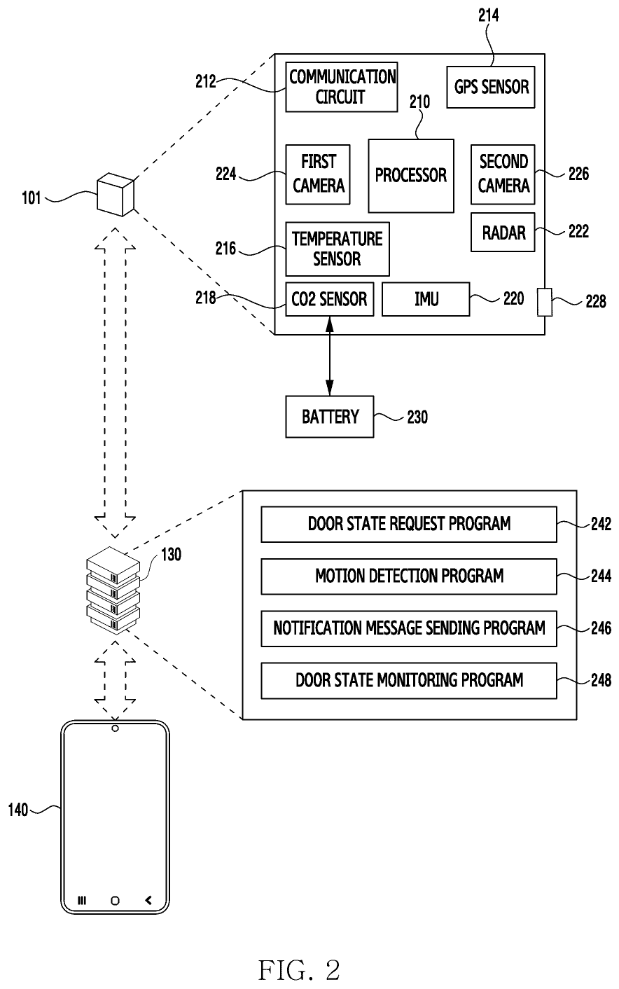

Hereinafter, referring to FIG. 2, it will be described an example of a hardware configuration of the electronic device 101 and/or the server 130 for detecting a motion inside the vehicle 110, and/or at least one program executed by the hardware configuration by way of example.

FIG. 2 illustrates an example block diagram of the electronic device 101, according to an embodiment. The electronic device 101, the server 130, and the user terminal 140 of FIG. 2 may include the electronic device 101, the server 130, and the user terminal 140 of FIG. 1.

Referring to FIG. 2, the electronic device 101, referred to as a drive video record system (DVRS), may include at least one of a processor (or an application processor, AP) 210, a communication circuit 212, a global positioning system (GPS) sensor 214, a temperature sensor 216, a carbon dioxide sensor 218, an inertial measurement unit (IMU) 220, a radar 222, a first camera 224, a second camera 226, or a port 228. According to embodiments, at least one of those electronic components of the electronic device 101 described above (e.g., radar 222) may be omitted. According to embodiments, the electronic device 101 may further include other electronic components that are different from the electronic components described above. In one embodiment, the electronic device 101 may acquire or receive a power signal from a battery 230 included in a vehicle (e.g., the vehicle 110 of FIG. 1). The electronic device 101 may detect a motion inside the vehicle in a certain state of the vehicle including a parked state.

In one embodiment, the processor 210 included in the electronic device 101 may execute instructions stored in memory (not shown). The processor 210 executing the instructions may cause the electronic device 101 to perform functions and/or actions associated with the instructions.

In one embodiment, the communication circuit 212 of the electronic device 101 may establish or control a communication connection between the electronic device 101 and the server 130, using the communication standard such as, e.g., LTE, LTE Cat (category) M1, and/or IMT-2020 (5G). For example, via the communication circuit 212, the processor 210 of the electronic device 101 may transmit signals to the server 130 or receive signals from the server 130. Through the communication circuit 212, the electronic device 101 may access a communication operator's network, private networks, and/or a public network to establish a communication link between the electronic device 101 and the server 130.

In one embodiment, the GPS sensor 214 may support not only a GPS scheme but also other communication methods (e.g., Galileo and/or BeiDou) for detecting a geographic location of the electronic device 101. The GPS sensor 214 may be referred to as a global navigation satellite system (GNSS).

In one embodiment, the first camera 224 included in the electronic device 101 may be disposed facing a front direction of the vehicle (e.g., the vehicle 110 of FIG. 1) that includes the electronic device 101. For example, the electronic device 101 may be mounted on an inside of the vehicle, such that one side of the electronic device 101 with the first camera 224 being exposed to the outside faces the front of the vehicle.

In one embodiment, the second camera 226 included with the electronic device 101 may be disposed facing an interior of the vehicle including the electronic device 101. For example, the second camera 226 may be at least partially exposed to the outside through a second side that is opposite the first side on which the first camera 224 is disposed.

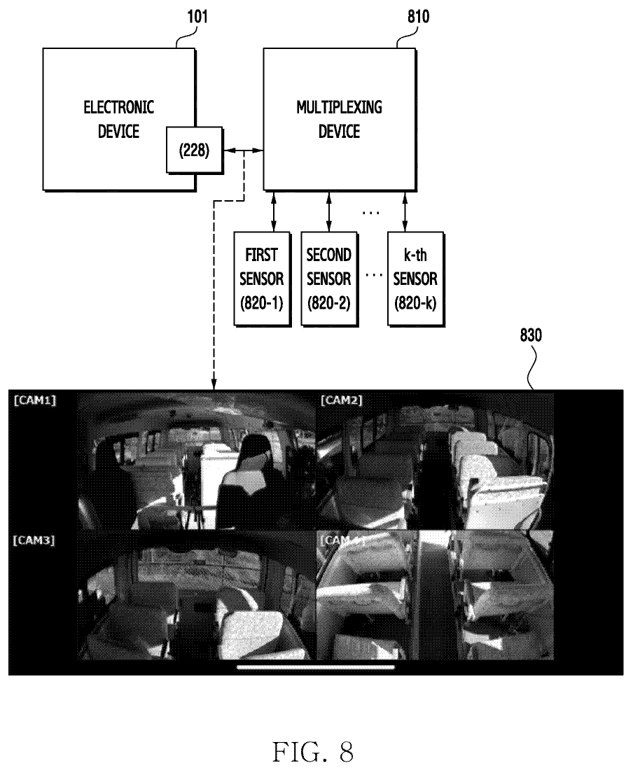

While an embodiment is described in which the electronic device 101 includes the first camera 224 and the second camera 226, embodiments are not limited thereto. The electronic device 101 may be electrically coupled, via the port 228, to other cameras mounted at locations spaced apart from the electronic device 101 (e.g., locations in the interior and/or exterior of the vehicle on which the electronic device 101 is mounted). For example, via the port 228, the electronic device 101 may be connected to a camera disposed facing the rear side of the vehicle. Independently of the port 228, the electronic device 101 may be wirelessly connected to the other camera using the communication circuit 212. Via the port 228, the electronic device 101 may be connected to a camera and/or a sensor distinct from the camera. In one embodiment, an example of connecting to a plurality of cameras via the port 228 is described with reference to FIG. 8.

In one embodiment, the processor 210 of the electronic device 101 may process images and/or video received from one or more cameras (e.g., the first camera 224, the second camera 226, and/or other cameras connected via the port 228), using, for example, an advanced driver assistance system (ADAS) algorithm, so as to recognize objects (such as other vehicles and/or people) from the images and/or video, or detect a motion thereof.

In one embodiment, the electronic device 101 may include a radar 222. The processor 210 may control the radar 222 and the second camera 226 in conjunction, or may control them independently. The radar 222 may radiate radio waves (e.g., microwaves). Radio waves reflected from the radar 222 may be reflected by any external objects, or may be distorted by motions of external objects (e.g., with Doppler effect). Using the radar 222, the electronic device 101 may receive or detect radio waves reflected or distorted from external objects. The radar 222 may be included in the electronic device 101, or may be separately located at an inside of the vehicle spaced apart from the electronic device 101.

The radar 222 may support a function to detect movement, such as human walking. In one embodiment, the radar 222 may use millimeter wave (mm Wave) technology. Specifically, the radar 222 according to an embodiment may use mmWave (hereinafter, referred to as “millimeter wave”) in a 60 GHz band. By utilizing millimeter waves, the radar 222 and/or the processor 210 connected to the radar 222 may penetrate solid materials, allowing for accurate location detection of a child in the vehicle and even predicting driver's vital signs. In one embodiment, the radar 222 may be installed in an interior of a vehicle, such as e.g., behind a headliner of a vehicle or inside a B pillar of a vehicle. In one embodiment, the radar 222 may utilize millimeter wave technology, so that the radar may not be affected by lighting and temperature conditions in the vehicle cabin. Referring to FIG. 2, the electronics 101 may include various types of sensors (e.g., a temperature sensor 216, a carbon dioxide sensor 218, and/or an IMU 220). The temperature sensor 216 may be adapted to output a numerical value (e.g., a digital value) associated with a temperature of the environment including the electronic device 101, or to parameterize the temperature. The temperature sensor 216 may be configured to output a temperature value with a unit of Fahrenheit and/or Celsius temperature. The carbon dioxide sensor 218 may be configured to parameterize, or output, a numerical value associated with the content of carbon dioxide contained in the air (e.g., air in the interior of the vehicle) in an environment surrounding the electronic device 101. The carbon dioxide sensor 218 may output a concentration value with a unit of ppm (parts per million). In one embodiment, the IMU 220 may include sensors to detect physical movement and/or rotation of the electronic device 101. For example, an acceleration sensor, a gyro sensor, a geomagnetic sensor, or any combination thereof may be referred to as the IMU 220.

According to an embodiment, the processor 210 of the electronic device 101 may detect a motion in the interior of the vehicle, using data (e.g., sensor data, images, and/or video) obtained from exemplary sensors, radars, cameras included in the electronic device 101 and/or external sensors, radars, and/or cameras connected via port 228. For example, the processor 210 may detect a living organism (e.g., a person and/or a pet) present in the interior of the vehicle, or detect motion of the living organism, using a neural network trained for object detection (OD). For example, the processor 210 may detect a living organism who is synthesizing carbon dioxide within the vehicle, using a carbon dioxide concentration in the interior of the vehicle detected using the carbon dioxide sensor 218. For example, the processor 210 may utilize the temperature sensor 216 to detect an increase in temperature caused by a living organism located within the vehicle. For example, the processor 210 may detect a presence of a living organism (a person and/or a pet, etc.) in the vehicle, by using a microphone installed in the in-cabin of the vehicle to use information from analyzing sounds (such as a child crying, screaming, etc.) generated in the vehicle. For example, the processor 210 may detect a presence of an object present on a vehicle seat, using a weight detection sensor mounted on the vehicle seat. In a case of detecting such motion in the interior of the vehicle, or detecting a living organism located in the interior of the vehicle, the processor 210 may transmit signals related to the motion and/or the detection of a living organism, to the server 130 via the communication circuit 212. In addition, the processor 210 may utilize a neural network trained for object detection (OD) to detect the presence or absence of personal belongings located in the vehicle cabin, and may notify a vehicle driver or a vehicle service manager of the detected personal belongings, if there is any detected personal belongings. In one embodiment, the processor 210 may detect any personal belongings located in the vehicle cabin after the vehicle is turned off, power supply is interrupted, or driving is terminated, and then notify the vehicle driver or the service manager of the detection, if any, thereby preventing the passengers of the vehicle from losing their personal belongings after getting off the vehicle.

According to an embodiment, an example of specific motions in an interior of a vehicle detected by the processor 210 of the electronic device 101 may be summarized in the following Table 1.

TABLE 1

| Object for | | | |
|---|---|---|---|
| Monitoring | Driver | Occupant | Children |
| Type of motion | Driver operating status: | Occupant status: | Detecting Children |
| inside vehicle | calling on the phone, | safety confirmation, | Detection of car seat |
| for detection | eating food, drinking, | riding condition, | for children and |
| | etc. | riding posture, etc. | wearing of seat belt |
| | Driver driving status: | Occupant movement | |
| | tiredness, tension, | detection: eating | |
| | drowsiness, carelessness, | food, using smartphone, | |
| | drunk driving, etc. | smoking, drinking, etc. | |
| | Driver authentication | Occupant condition | |
| | Driver posture | detection: riding | |
| | Seat belt detection | state, posture, other | |
| | Gesture control | safety-related actions | |
| | Body pose | Wearing seatbelt | |
| | Driver gaze detection | Detecting pets | |
| | | Detecting other objects | |

Referring to FIG. 2, illustrated are example programs installed on the server 130, such as, e.g., a door state request program 242, a motion detection program 244, a notification message sending program 246, and/or a door state monitoring program 248. To execute the illustrated programs, the server 130 may include a processor, memory, and/or communication circuit. However, embodiments are not limited thereto. Upon receiving from the electronic device 101 a signal indicating activation of the electronic device 101 (e.g., activation of the electronic device 101 based on ceasing of charging by the battery 230), the server 130 may execute the door state request program 242. By executing the door state request program 242, the server 130 may request signals and/or information, from the electronic device 101, relating to the status of the doors of the vehicle including the electronic device 101. Hereinafter, executing a program by the server 130 and/or the electronic device 101 may mean not only initiating and/or instantiating the program, but also executing a certain function and/or operation of the program described herein. When the states of the doors of the vehicle including the electronic device 101 correspond to a closed state, the server 130 may execute the motion detection program 244. Determining the states of the doors in the vehicle may be performed based on execution of the door state monitoring program 248.

By executing the motion detection program 244, the server 130 may obtain and/or process sensor data (e.g., images and/or video detected by various cameras, and/or sensor data detected by various sensors) transmitted from the electronic device 101. The motion detection program 244 may include algorithm for processing the sensor data based on big data. By executing the motion detection program 244, the server 130 may detect motion inside the vehicle including the electronic device 101.

When detecting the motion in the inside of the vehicle, the server 130 may execute the notification message sending program 246. By executing the notification message sending program 246, the server 130 may transmit a notification message related to the motion, to the electronic device 101 and/or to a user terminal 140 of a user associated with the vehicle including the electronic device 101. The embodiment is not limited thereto, and the server 130 may send the notification message to another server of a government agency (e.g., a fire department and/or a police department) involved in the emergency situation. The server 130 may send the notification messages to various devices connected via a network, such as autonomous vehicles.

The server 130 executing the notification message sending program 246 may transmit, to the user terminal 140, a notification message indicating a state of the electronic device 101 and/or the vehicle including the electronic device 101. For example, when an SOC of the battery included in the electronic device 101 and/or the battery 230 of the vehicle is below a designated threshold of SOC, the server 130 may send a notification message, to the user terminal 140, including text related to the SOC. An example of notification messages transmitted from the server 130 to the user terminal 140 are by way of example described with reference to FIG. 4.

Based on execution of the notification message sending program 246, the server 130 may manage a list of user terminals 140 to which notification messages related to the vehicle (e.g., notification messages to inform detection of a motion and/or notification messages to inform inputs related to an emergency control means) are to be transmitted. The list may be managed by an application running on the user terminal 140, a text message sent to the user terminal 140, a text message received from the user terminal 140, and/or a web page (or website) provided by the server 130. For example, a user of the user terminal 140 may use an SMS to send a text message, to the server 130, including a phone number assigned to the user terminal 140. Upon receiving the text message, the server 130 may add the phone number to the list, based on execution of the notification message sending program 246.

Although an embodiment has been described in which the server 130 processes sensor data collected by the electronic device 101, embodiments are not limited thereto. For example, the electronic device 101 may execute a neural network independently of server 130 to perform an object recognition associated with a second camera 226 and/or other cameras connected via port 228. Here, the neural network may include hardware (e.g., CPU, graphic processing unit (GPU), and/or neural processing unit (NPU)), software, or a combination thereof, for simulating cognitive and/or reasoning activities of an organism such as a human. For example, by driving such a neural network, the processor 210 of the electronic device 101 may perform systematized computations with a structure such as, e.g., a convolutional neural network (CNN), feedforward neural network (FFN), recurrent neural network (RNN), and/or long short term memory (LSTM).

Hereinafter, Referring to FIG. 3, an example operation of the electronic device 101 and/or the processor 210 described with reference to FIGS. 1 and 2 will be described in detail.

FIG. 3 illustrates an example flowchart of operations performed by an electronic device, according to an embodiment. The operations of the electronic device described with reference to FIG. 3 may be performed by the electronic device 101 of FIGS. 1 and 2 and/or the processor 210 of FIG. 2.

Referring to FIG. 3, in operation 310, the processor of the electronic device according to an embodiment may detect termination of operation (driving) of a vehicle (e.g., the vehicle 110 of FIG. 1). Upon termination of operation of the vehicle, an electrical connection between a battery included in the vehicle (e.g., the battery 230 in FIG. 2) and the electronic device may be disconnected. While the vehicle is in operation, the electronic device may be charged by the battery. The electronic device may be activated by another battery (e.g., a supercapacitor) included in the electronic device, notwithstanding the disconnection of the electrical connection between the battery and the electronic device. Since the electronic device utilizes another battery that is distinct from the battery of the vehicle, discharge of the vehicle battery due to a continuous operation of the electronic device may be prevented.

Upon detecting the termination of operation of the vehicle, the processor may transmit a signal to a server (e.g., server 130 of FIGS. 1 and 2), informing that the electronic device is in operation. In response to the signal, the server may request information from the electronic device about the state of the doors of the vehicle (e.g., closed state and/or open state).

Referring to FIG. 3, in operation 320, the processor of the electronic device according to an embodiment may detect states of the doors of the vehicle. The states of the doors may be detected by switching circuits located on the doors, respectively. Referring to the operations 310 and 320, the processor may detect the states of the doors of the vehicle, based on the termination of power received from the battery of the vehicle. The processor may transmit a signal including the states of the doors to the server. The server may use the signal to determine or identify the states of the doors of the vehicle.

Referring to FIG. 3, in operation 330, the processor of the electronic device according to an embodiment may determine whether all of the doors of the vehicle correspond to a closed state. When at least one of the doors is in an open state (operation 330—No), the processor may perform the operation 320 to track or monitor the states of the doors. The embodiment is not limited thereto, and the server connected with the electronic device may also determine whether all of the doors correspond to a closed state, using the signal transmitted from the electronic device.

Referring to FIG. 3, when all of the doors correspond to the closed state (operation 330—Yes), the processor may perform operation 340. In response to detecting all of the doors of the vehicle corresponding to the closed state, the server may request that the electronic device detect motion inside the vehicle. For example, detecting the motion inside the vehicle may be performed while the operation of the vehicle is terminated and all of the doors of the vehicle are locked.

In one embodiment, the electronic device may include an antenna associated with an ultra-wideband (UWB). The processor may control the antenna in response to detecting the states of the doors corresponding to the closed state. By controlling the antenna, the processor may detect a wireless signal that is included in the UWB and transmitted from a remote controller (e.g., a remote key) corresponding to the vehicle. Using the position of the remote controller with respect to the vehicle, calculated from the wireless signal detected using the antenna, the processor may use the sensor date to determine whether to detect a motion inside the vehicle (specifically, motion of an object in the vehicle cabin).

Referring to FIG. 3, in operation 340, according to an embodiment, the processor of the electronic device may receive the sensor data from the sensors in the vehicle. These sensors, in operation 340, may include sensors included in the electronic device (e.g., first camera 224, second camera 226, temperature sensor 216, carbon dioxide sensor 218, IMU 220, and/or radar 222 of FIG. 2), as well as other sensors wiredly and/or wirelessly connected to the electronic device (e.g., in-vehicle sensors connected via the port 228 of FIG. 2). For example, the processor may receive the sensor data from a plurality of sensors disposed inside the vehicle, via the port, in response to detecting the states of the doors corresponding to the closed state. The sensor data received in operation 340 may be transmitted to the server connected to the electronic device.

In operation 340, the processor may activate sensors in the vehicle. For example, a radar installed in the vehicle may be controlled by the processor performing the operation 340 and may emit radio waves (e.g., microwaves) by the processor. In this example, the processor may receive sensor data associated with radio waves detected by the radar (e.g., reflected waves of a wavelength corresponding to the radio waves emitted by the radar).

Referring to FIG. 3, in operation 350, the processor of the electronic device according to an embodiment may determine, using the sensor data, whether a motion inside the vehicle has been detected. If the processor detected a motion inside the vehicle, it may perform operation 360. In response to detecting no in-vehicle motion, the processor may bypass the operation 360, or may perform another operation (e.g., operation 370). For example, the processor may detect the in-vehicle motion by performing object recognition on a video acquired from the camera. For example, using a change in a reflected wave received from a radar, the processor may detect a motion in the vehicle. For example, based on an increase in carbon dioxide concentration measured by a carbon dioxide sensor, the processor may detect a living organism within the vehicle and/or a motion of the living organism. For example, based on a change in temperature measured by a temperature sensor, the processor may detect a motion. For example, the processor may detect any motion inside the vehicle (e.g., motion of an object (e.g., person and/or animal) in the vehicle), by comparing the sensor data and a threshold associated with the sensor data.

While an embodiment has been described in which the processor detects motion of the motion 350, embodiments are not limited thereto. For example, if the processor transmits and/or relays the sensor data of the operation 340 to a server, the server may utilize the sensor data to detect motion.

Referring to FIG. 3, in operation 360, the processor of the electronic device according to an embodiment may send an alarm for the motion. Having detected the motion inside the vehicle using the sensor data in the operation 340, the processor may send a signal via a communication circuit (e.g., the communication circuit 212 in FIG. 2) to an external electronic device (e.g., the server and/or the user terminal 140 in FIGS. 1 and 2) to provide an alarm associated with the motion. In response to receiving the signal or having directly detected the motion using sensor data, the server may transmit a signal (e.g., a signal comprising a notification message) associated with the alarm to a user terminal of a user associated with the electronic device and/or the vehicle.

Having transmitted the alarm in operation 360, the processor may transmit the alarm of action 360 repeatedly (or periodically), until at least one of the doors gets opened. For example, for a specified period of time (e.g., 10 minutes) after sending the alarm in operation 360, the processor may check the state of the doors. If all of the doors remain in the closed state, in response to expiration of the specified time period, the processor may again transmit the alarm of operation 360. When at least one of the doors switches to the open state, the processor may not transmit the alarm of operation 360 anymore.

Embodiments are not limited thereto, and the server connected to the electronic device may monitor the states of the doors for a specified period of time after transmitting the alarm of operation 360 to determine whether to resend the alarm. For example, the server may request the states of the doors from the electronic device at the time of expiration of the specified period of time after sending the alarm. Upon receiving a signal from the electronic device indicating the state of the doors corresponding to the closed state, the server may resend the alarm of operation 360.

The processor of the electronic device that detected the motion in the vehicle may control the vehicle to output the alarm to an external environment adjacent to the vehicle, as well as remotely transmitting the alarm. For example, the electronic device that has detected the motion using the sensor data may blow the vehicle horn and/or activate (e.g., flicker) a light emitting component of the vehicle.

Referring to FIG. 3, after receiving the sensor data based on the operation 340, the processor may perform operations 370, 380 and 390 to determine whether to stop detecting motion. In operation 370, the processor of the electronic device according to an embodiment may determine whether at least one of the doors is in an open state. When at least one of the doors switches from a closed state to the open state (operation 370—Yes) while receiving the sensor data, the processor may perform operation 380. When all of the doors remain in the closed state (operation 370—No), the processor may perform operation 390. Embodiments are not limited thereto, and the server that has transmitted the alarm about the motion may also request a signal from the electronic device indicating the states of the doors. Using the signal, the server may determine whether at least one of the doors is open.

Referring to FIG. 3, in operation 390, the processor of the electronic device according to an embodiment may determine whether a specified period of time for detecting motion has expired. The specified period of time may be predefined in a range between 10 and 15 minutes. The specified period of time may be determined heuristically based on at least one of an internal battery (e.g., supercapacitor) included in the electronic device and/or a time period required to detect motion using sensor data. During the specified period of time (operation 390—No), the processor may maintain detecting motion using the sensor data of operation 340. In response to expiration of the specified time period (operation 390—Yes), the processor may perform operation 380. Embodiments are not limited thereto, and the server associated with the electronic device may also determine whether the specified time period of operation 390 has expired.

Referring to FIG. 3, in operation 380, the processor of the electronic device according to an embodiment may cease detecting motion using the sensor data. The server connected to the electronic device may also cease receiving the sensor data, similar to the processor performing the operation 380. In operation 380, the processor may stop sending the sensor data to the server. After the motion detection has ceased, the electronic device may be recharged by the vehicle battery, when the vehicle resumes its operation. After the charging is interrupted, the processor may again perform the operations of FIG. 3.

As described above, according to an embodiment, the electronic device and/or the server connected with the electronic device may perform an operation for detecting motion inside the vehicle that has completed its traveling. Upon detecting a motion, the electronic device and/or the server may provide an alarm to a user, which may trigger an urgent action of the user related to the motion. Hereinafter, referring to FIG. 4, it is described an example of a notification message provided by the electronic device and/or the server performing the operation 360.

FIG. 4 illustrates an example of text messages displayed on a user terminal 140 by a signal transmitted from the electronic device 101, according to an embodiment. Referring to FIG. 4, an example display state are shown in which the electronic device 101 and/or the server 130, having performed the operations described above with reference to FIGS. 1 through 3, has transmitted a notification message to the user terminal 140. The user terminal 140 may visualize the notification message received from the electronic device 101 and/or the server 130 via a display 410.

Referring to FIG. 4, exemplary visual objects (420, 430, 440, 450) are shown on a screen that are displayed by the user terminal 140 in response to receiving a notification message from the electronic device 101 and/or the server 130. The visual objects (420, 430, 440, 450) may be displayed via a user interface (UI) referred to as a notification center (or notification panel), as provided by an Android operating system. The visual objects (420, 430, 440, 450) may be displayed on the display 410 in the form of a pop-up window (e.g., toast). The visual objects (420, 430, 440, 450) may be visualized in the form of bubbles to sectionize text messages managed by a messenger application, in a UI provided by the messenger application.

Referring to FIG. 4, as seen in the visual object 420, the electronic device 101 and/or the server 130 may send, to the user terminal 140, a notification message with a natural language sentence (e.g., “Motion detected inside a vehicle numbered [11GA0000]. Please check inside of the vehicle.”), including text (e.g., a license plate number such as “11GA0000”) to specify a certain vehicle in which motion has been detected. In response to receiving the notification message, the user terminal 140 may display the visual object 420 with the natural language sentence included in the notification message, on the display 410.

Referring to FIG. 4, the electronic device 101 and/or the server 130 may, in response to an input (e.g., an input of pressing an emergency bell) received via an emergency control means (such as, e.g., an emergency bell and/or an emergency button) disposed on the vehicle, transmit a notification message to the user terminal 140 to inform the user of the input. In response to the notification message, the user terminal 140 may display, on the display 410, a visual object 430 with a natural language sentence including text for specifying a vehicle (e.g., “This is an emergency situation. Please check inside of a vehicle numbered [11GA0000].”). In one embodiment, the emergency control means may be operated independently of the closed state of the doors of the vehicle. For example, the electronic device 101 and/or the server 130 may send the notification message to the server 130 in response to an input associated with the emergency control means, even though at least one of the doors of the vehicle corresponds to a state different from the closed state.

Referring to FIG. 4, the electronic device 101 and/or the server 130 may transmit a notification message to the user terminal 140 related to a state (e.g., SOC and/or charge charge) of an internal battery of the electronic device 101 and/or a battery of the vehicle (e.g., the battery 230 of FIG. 2). For example, the electronic device 101 and/or the server 130, which periodically (or repeatedly) checks the state, may send to the server 130 a notification message relating to the SOC of the internal battery of the electronic device 101 when the SOC of the internal battery is reduced below a threshold SOC (e.g., 15%). Upon receiving the notification message, the server 130 may display a visual object 440 including a natural language sentence associated with the internal battery of the electronic device 101 (e.g., “Remaining battery charging of a wireless communication terminal in the vehicle numbered [11GA0000] is below threshold. Detection is not available.” or “Detection is not available because the remaining battery charging of a wireless communication terminal in the vehicle numbered [11GA0000] is insufficient.”).

Referring to FIG. 4, the electronic device 101 and/or the server 130 may support streaming of a video obtained from the electronic device 101 and/or at least one camera disposed in the vehicle, in response to detecting a motion inside the vehicle. For example, the electronic device 101 and/or the server 130 detecting the motion may transmit, to the user terminal 140, a text message related to the alarm for the motion and a signal including a hyperlink for establishing a communication link related to streaming of the video. The hyperlink may include an address (e.g., a uniform resource location (URL), a uniform resource indicator (URI), an IP address and/or a media access control (MAC) address) of the electronic device 101 in a network, and/or a port number of the electronic device 101 related to the streaming. Upon receiving the signal, the user terminal 140 may display a visual object 450 including the text message and the hyperlink 455 on the display 410. In response to a user input of touching or clicking the hyperlink 455, the user terminal 140 may request the server 130 and/or the electronic device 101 to establish a communication link.

In an embodiment, the electronic device 101 and/or the server 130 may receive a signal including a request related to streaming of a video, from an external electronic device such as the user terminal 140. In response to the signal, the electronic device 101 and/or the server 130 may establish a communication link between the user terminal 140 and the electronic device 101. Through the communication link, the electronic device 101 may provide the video received from the electronic device 101 and/or at least one camera disposed in the vehicle, to the user terminal 140. Upon receiving the video, the user terminal 140 may output or play the video on at least a portion of the display 410.

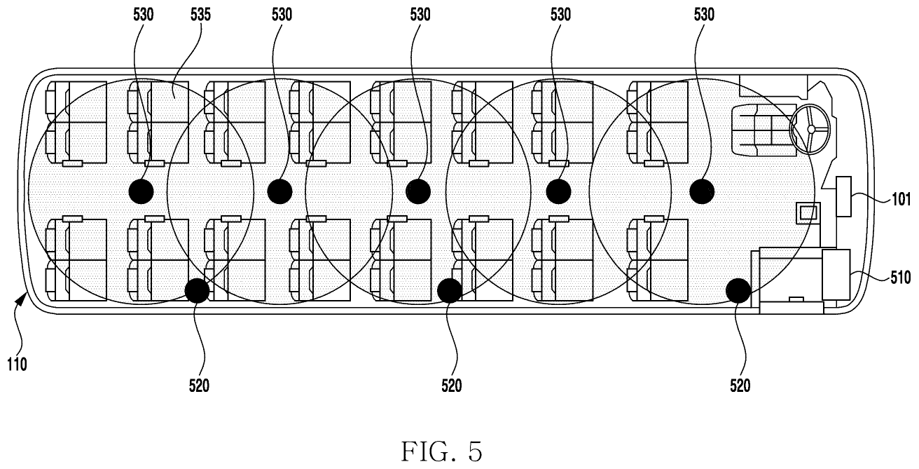

Hereinafter, sensors disposed inside the vehicle to detect motion will be described with reference to FIG. 5.

FIG. 5 illustrates example sensors distributed inside the vehicle 110 including the electronic device 101, according to an embodiment. The electronic device 101 of FIGS. 1 to 4 and/or the processor 210 of FIG. 2 may perform an operation of the electronic device 101 described with reference to FIG. 5. The sensors in the vehicle 110 described with reference to FIG. 5 may be an example of the sensors 120 of FIG. 1.

Referring to FIG. 5, the electronic device 101 may be connected to at least one of motion detection sensors 530 inside the vehicle 110 (e.g., radar and/or camera), emergency control means 520, and/or a door sensor 510, within the vehicle 110 having the bus-type appearance. The motion detection sensors 530, the emergency control means 520, and/or the door sensor 510 may have a wired connection with the electronic device 101 or may be wirelessly connected with the electronic device 101.

Referring to FIG. 5, in one embodiment in which the motion detection sensors 530 correspond to radars, the motion detection sensors 530 may detect a motion generated in an exemplary area 535 illustrated in a circle. The area 535 may be a region in which the radar can receive radio waves (e.g., reflected waves for radio waves radiated from an antenna of the radar). The electronic device 101 may detect a motion generated in the region 535, by using a change in amplitude of the reflected wave detected by the radar.

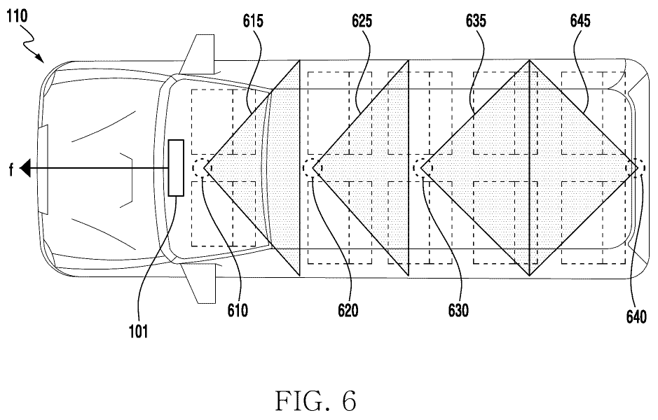

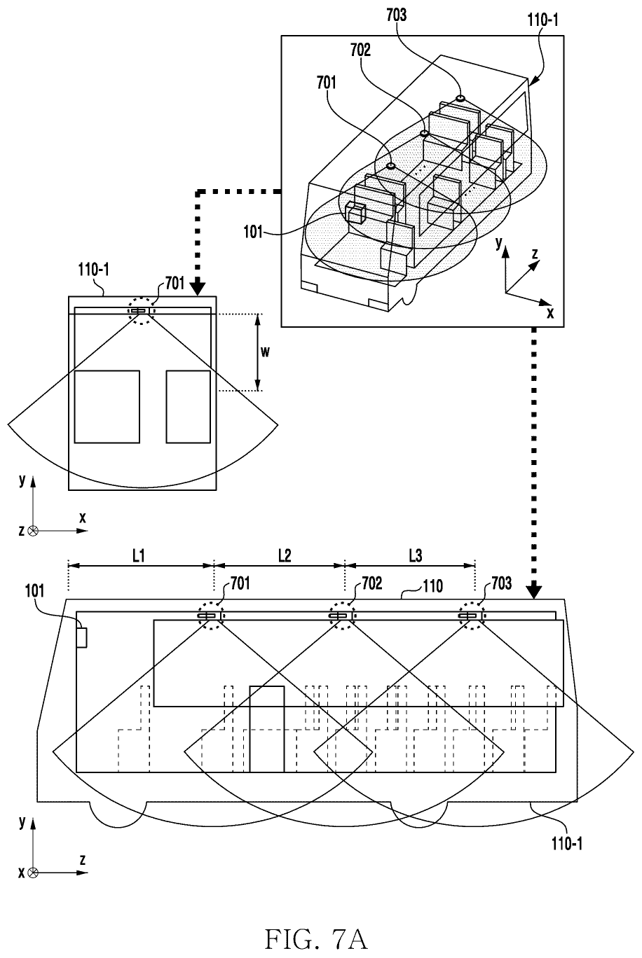

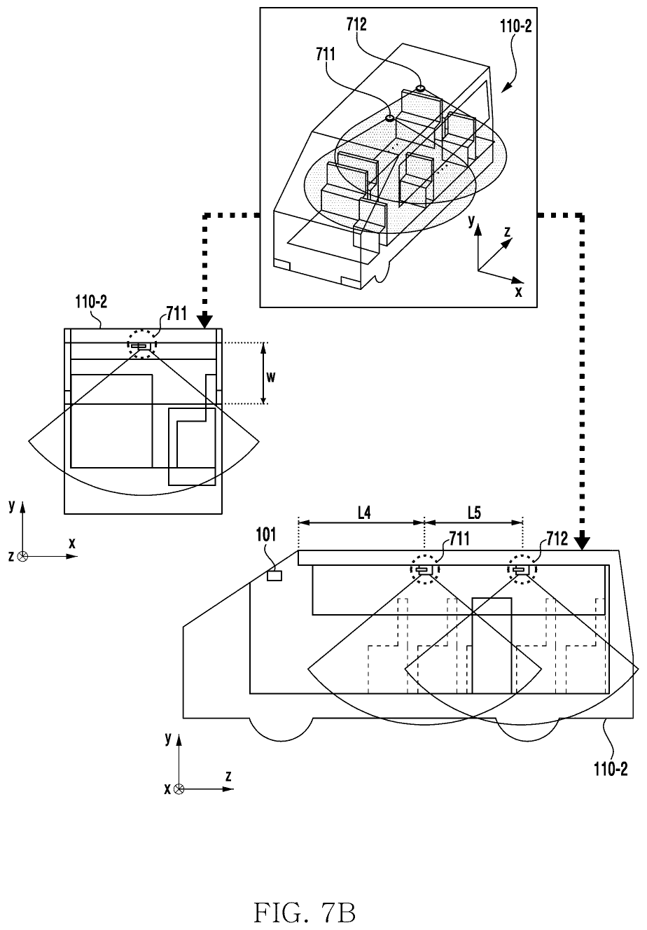

In an embodiment in which the motion detection sensors 530 are cameras, an example position of a camera inside the vehicle 110 related to a field-of-view (FOV) of the camera will be described with reference to FIG. 6. In an embodiment in which the motion detection sensors 530 are radars, example positions of radars according to the shape and/or dimensions (e.g., overall length, full width, and/or full height) of the vehicle 110 will be described with reference to FIGS. 7A and/or 7B.

The door sensor 510 disposed in or on the door of the vehicle 110 may transmit a signal indicating a state of the door (e.g., a closed state and/or an open state) to the electronic device 101. The electronic device 101 may transmit the signal received from the door sensor 510 to the server, in response to a request (e.g., the request for the state of the door of the vehicle 110) received from the server (e.g., the server 130 of FIG. 1 or 2).

The emergency control means 520 disposed in the vehicle 110 may have the form of an emergency bell, an emergency button, and/or an emergency lever. When a user in the vehicle 110 performs a gesture related to the emergency control means 520 (e.g., when an emergency bell is pressed, an emergency button is pressed, and/or an emergency lever is tilted), the electronic device 101 may receive a signal indicating detection of the gesture from the emergency control means 520. Upon receiving the signal, the electronic device 101 may transmit a signal indicating detection of the gesture related to the emergency control means 520, to the server and/or the user terminal (e.g., the user terminal 140 of FIG. 1).

As described above, the electronic device 101 mounted in the vehicle 110 having a relatively large size, such as e.g., a bus, may detect a motion inside the vehicle 110 using the sensors distributed in the vehicle 110.

FIG. 6 illustrates example positions of a plurality of cameras (610, 620, 630, 640) distributed inside a vehicle 110 including an electronic device 101, according to an embodiment. The electronic device 101 of FIGS. 1 to 4 and/or the processor 210 of FIG. 2 may perform an operation of the electronic device 101 described with reference to FIG. 6. The plurality of cameras (610, 620, 630, 640) arranged in the vehicle 110 of FIG. 6 may be an example of the sensors 120 of FIG. 1.

Referring to FIG. 6, it is illustrated an example of the electronic device 101 disposed to face a front side of the vehicle 110 (e.g., in a forward direction f). For example, any one face (e.g., the front surface of the electronic device 101), on which a first camera (e.g., the first camera 224 of FIG. 2) of the electronic device 101 is disposed, may be disposed to face the forward direction f of the vehicle 110.

Referring to FIG. 6, an example structure of the vehicle 110 including the electronic device 101 is illustrated. A driver's seat, at least one assistant passenger seat, and one or more seats for one or more other passengers may be arranged inside the vehicle 110. Components included inside the vehicle 110 are not limited thereto, and for example, the vehicle 110 may further include a partition (e.g., an object referred to as a protector) for protecting a passenger, a guard plate for protecting the driver, an emergency exit, stairs (e.g., movable stairs), and a foldable seat.

Referring to FIG. 6, the vehicle 110 may include cameras (610, 620, 630, 640) disposed to minimize a blind spot inside the vehicle 110. The number, locations, and/or directions of those cameras (610, 620, 630, 640) included in the vehicle 110 are not limited to those of the embodiment of FIG. 6. Referring to FIG. 6, the regions (615, 625, 635, 645) that may be recorded by each of the cameras (610, 620, 630, 640) are illustrated by way of example. Each of the regions (615, 625, 635, 645) may be referred to as a field-of-view (FoV) of a corresponding camera. The areas (615, 625, 635, 645) may be formed by the cameras (610, 620, 630, 640) disposed to cover different portions and/or seats inside the vehicle 110. Embodiment are not limited thereto, and the cameras may be arranged not only inside the vehicle 110 but also outside the vehicle 110 (e.g., a front side (f), a rear side, a left side, a right side, an upper room, and/or a lower side of the vehicle 110).

Although the cameras (610, 620, 630, 640) each having fixed positions inside the vehicle 110 are illustrated as an example, embodiments are not limited thereto. For example, the FoV, the direction (e.g., an angle of a mount on which the camera is arranged), the position, and/or a photographing target of the camera disposed in the vehicle 110 may be changed.

In an embodiment connected with the example (610, 620, 630, 640) of FIG. 6, the electronic device 101 may receive sensor data including videos captured from the cameras (610, 620, 630, 640). The electronic device 101 may perform object recognition on the video by using a neural network to which the video received from at least one of the cameras (610, 620, 630, 640) is input. The neural network may be an on-device neural network executable by the electronic device 101. The electronic device 101, which detected an external object different from the vehicle 110 (or objects disposed in the vehicle 110) from the video by using the object recognition, may transmit a signal informing detection of the external object to an external electronic device through a communication circuit (e.g., the communication circuit 212 of FIG. 2). Upon receiving the signal, the server may transmit a notification message (e.g., the visual objects 420, 430, 440, and 450 of FIG. 4) based on the signal, to the user terminal corresponding to the electronic device 101.

FIGS. 7A and/or 7B illustrate example positions of a plurality of radars (701, 702, 703, 711, 712) distributed inside the vehicles 110-1 and 110-2 having different dimensions. The electronic device 101 of FIGS. 1 to 4 and/or the processor 210 of FIG. 2 may perform an operation of the electronic device 101 described with reference to FIGS. 7A and/or 7B.

Referring to FIGS. 7A and/or 7B, the vehicles 110-1 and 110-2 having different dimensions and radars (701, 702, 703, 711, 712) included in each of the vehicles 110-1 and 110-2 are illustrated as an example. The beam pattern of each of the radars (701, 702, 703, 711, 712) may be formed in a conical shape and may have a viewing angle of about 100° in a first direction (e.g., the vertical direction) and a second direction (e.g., the horizontal direction) perpendicular to the first direction.

Referring to FIG. 7A, an example of the vehicle 110-1 including three radars (701, 702, 703) is illustrated. The radars (701, 702, 703) may be disposed along a center line of a ceiling of the vehicle 110-1 parallel to a driving direction of the vehicle 110-1. The radar 701 may be spaced apart, by a length L1, from a boundary between an A pillar and the ceiling of the vehicle 110-1 or a boundary between a front glass and the ceiling of the vehicle 110-1, along the center line. The radar 702 may be spaced apart, by a length L2, from the radar 701, along the center line. The radar 703 may be spaced apart, by a length L3, from the radar 702 along the center line. The lengths L1, L2, and L3 of FIG. 7A may be determined as values in units of meters in the following Table 2 with respect to the full length of the vehicle 110-1.

TABLE 2

| | | | | | | Detection |
|---|---|---|---|---|---|---|
| Full Length | L1 | L2 | | L3 | | Distance (h) |
| 6.2 m | 2 m | 1.5 | m | 1.5 | m | 2.4 m |
| 7 m | 2 m | 2 | m | 2 | m | 2.4 m |
| 6.2 m | 2 m | 1.5 | m | 1.5 | m | 2.4 m |
| 7.0 m | 2 m | 2 | m | 2 | m | 2.4 m |

In Table 2, the detection distance h is a limit distance between the radar and the external object, wherein the radar may detect an external object located at a distance spaced apart by less than the detection distance h. Referring to FIG. 7A, the beam patterns of the radars (701, 702, 703) may be formed not to overlap the glass having the height w in order to minimize transmission of radio waves through the glass (e.g., the front glass, the rear glass, and/or the side glass) of the vehicle.

In an embodiment of FIG. 7A, the electronic device 101 in the vehicle 110-1 may receive sensor data from the radars (701, 702, 703). The sensor data may include a numerical value representing an intensity (or amplitude) of a reflected wave with respect to a radio wave radiated from each of the radars (701, 702, 703). When there is present a person inside the vehicle 110-1, the intensity of the reflected wave may be changed as the person moves therein. The electronic device 101 may detect the motion inside the vehicle 110-1 by using the amount of change and/or the rate of change in the intensity of the reflected wave.

Referring to FIG. 7B, an example of a vehicle 110-2 including two radars 711 and 712 is illustrated. The radars 711 and 712 may be disposed along a center line of the ceiling of the vehicle 110-2, which is parallel to the driving direction of the vehicle 110-2. The radar 711 on the center line may be spaced apart, by a length L4, from the boundary between the A pillar and the ceiling of the vehicle 110-2 or the boundary between the front glass and the ceiling of the vehicle 110-2. The radar 712 on the center line may be spaced apart, by a length L5, from the radar 711. The lengths L4 and L5 of FIG. 7B may be determined as values in units of meters in the following Table 3 with respect to the full length field of the vehicle 110-2.

TABLE 3

| | | | Detection |
|---|---|---|---|
| Full Length | L4 | L5 | Distance (h) |
| 4.7 m | 2.5 m | 1 m | 1.6 m |
| 5 m | 2.5 m | 1.5 m | 1.6 m |
| 5.2 m | 2.5 m | 1.5 m | 1.6 m |
| 5.4 m | 2.5 m | 1.5 m | 1.6 m |
| 4.8 m | 3 m | 1 m | 1.6 m |

The detection distance h in Table 3 may mean a distance that is detectable by beam patterns of the radars 711 and 712, as seen in the detection distance h of Table 1 above. Referring to FIG. 7B, the beam patterns of the radars 711 and 712 may be formed not to overlap the glass having the height w in order to minimize transmission and/or loss of the radio waves through the glass of the vehicle.

In an embodiment of FIG. 7B, the electronic device 101 in the vehicle 110-2 may detect an external object (e.g., a human and/or a living organism such as e.g., a pet) moving in the vehicle 110-2, by using sensor data received from the radars 711 and 712. The electronic device 101 may detect the motion of the external object and/or the motion of the external object, by using a change in the intensity of the reflected wave (e.g., the reflected wave for the radio wave forming the beam pattern illustrated in FIG. 7B) detected by the radars 711 and 712.

As described above, various number of sensors may be disposed in the vehicle. In order to communicate with such various number of sensors, the electronic device 101 may acquire or receive sensor data of the sensors through a wired connection, using multiplexing of the sensor data of the sensors. Hereinafter, an example connection between the electronic device 101 and the sensors related to multiplexing is illustrated with reference to FIG. 8.

FIG. 8 illustrates an example of wired connection between the electronic device 101 and one or more sensors (820-1, 820-2, . . . , 820-k), according to an embodiment. The electronic device 101 of FIGS. 1 to 4 and/or the processor 210 of FIG. 2 may perform an operation of the electronic device 101 described with reference to FIG. 8.

Referring to FIG. 8, the electronic device 101 may be connected to a multiplexing device 810 through the port 228. The multiplexing device 810 may be connected to k sensors (820-1, 820-2, . . . , 820-k) disposed in the vehicle, via a plurality of second ports different from a first port connected to the port 228. The multiplexing device 810 may multiplex the electrical signals transmitted from k sensors (820-1, 820-2, . . . , 820-k) to generate or obtain an integrated electrical signal to be output to the port 228.

Referring to FIG. 8, when four cameras are connected through the multiplexing device 810, the integrated electrical signal transmitted from the multiplexing device 810 to the electronic device 101 may include a combination of videos obtained from each of the four cameras. Referring to FIG. 8, it is illustrated an example image frame 830 represented by the integrated electrical signal. The image frames of the videos in the image frame 830 may be arranged in the layout of a picture-by-picture (PBP) scheme or a picture-in-picture (PIP) scheme. The image frames of the videos may be tiled in the frame 830 by the multiplexing device 810. For example, in the image frame 830, each of the image frames of the videos may have positions that do not overlap each other. In the image frame 830, the multiplexing device 810 may imbed an identifier of the camera (e.g., “CAM1”, “CAM2”, “CAM3”, and “CAM4”) that has obtained the video into each of the image frames included in the videos.

The electronic device 101 that has received the integrated electrical signal from the multiplexing device 810 may obtain sensor data of each of the k sensors (820-1, 820-2, . . . , 820-k) from the integrated electrical signal. For example, the electronic device 101 may perform demultiplexing to segment or extract the sensor date of each of the k sensors (820-1, 820-2, . . . , 820-k) from the integrated electrical signal. In one embodiment, upon receiving the integrated electrical signal including the image frame 830, the electronic device 101 may perform a crop on the image frame 830 to obtain image frames of each of the four cameras from the image frame 830. Using the sensor data extracted from the integrated electrical signal, the electronic device 101 may detect the motion inside the vehicle, as described above with reference to FIGS. 1 to 4.

In an embodiment of using the multiplexing device 810 to multiplex electrical signals of the k sensors (820-1, 820-2, . . . , 820-k), the multiplexing device 810 may support multiplexing of less than k electrical signals. When the maximum number of electrical signals multiplexed by the multiplexing device 810 is less than the number of sensors disposed in the vehicle, the multiplexing device 810 may preferentially (or selectively) multiplex electrical signals of certain sensors, by using the priority of each of the sensors.

The multiplexing device 810 may select or determine a plurality of electrical signals to be multiplexed among the electrical signals of the k sensors (820-1, 820-2, . . . , 820-k), using the state of each of the k sensors (820-1, 820-2, . . . , 820-k). For example, multiplexing of electrical signals of the remaining sensors other than the sensor that is in a state (e.g., a faulty state and/or an inactive state) different from a normal state may be performed by the multiplexing device 810. The multiplexing device 810, which multiplexes electrical signals of first sensors in the normal state among the k sensors (820-1, 820-2, . . . , 820-k), may multiplex the electrical signals of any one of second sensors that are different from the first sensors, in the event that a particular sensor of the first sensors has switched to a faulty state (or when an electrical signal has not received from the particular sensor).

Heretofore, although it is illustrated an embodiment in which videos of the cameras are multiplexed, embodiments are not limited thereto. In an embodiment in which a plurality of radars are connected to the multiplexing device 810, the image frame 830 may include distributions (or two-dimensional images representing such distributions) of radio waves detected by each of the plurality of radars.

As described above, according to an embodiment, the electronic device 101 may detect a motion inside the vehicle, using sensor data received from one or more sensors included in the vehicle and/or from sensors included in the electronic device 101. Such detection of motion by the electronic device 101 may be performed while the operation of the vehicle is stopped and all of the doors of the vehicle are closed. The electronic device 101 may be charged only while the vehicle is operating to prevent the battery of the vehicle from being discharged. The electronic device 101 may transmit sensor data to the server so that the server detects a motion. Embodiments are not limited thereto, and the electronic device 101 may process the sensor data independently of the server to detect motion, so as to reduce the resources of the server used to detect motion.

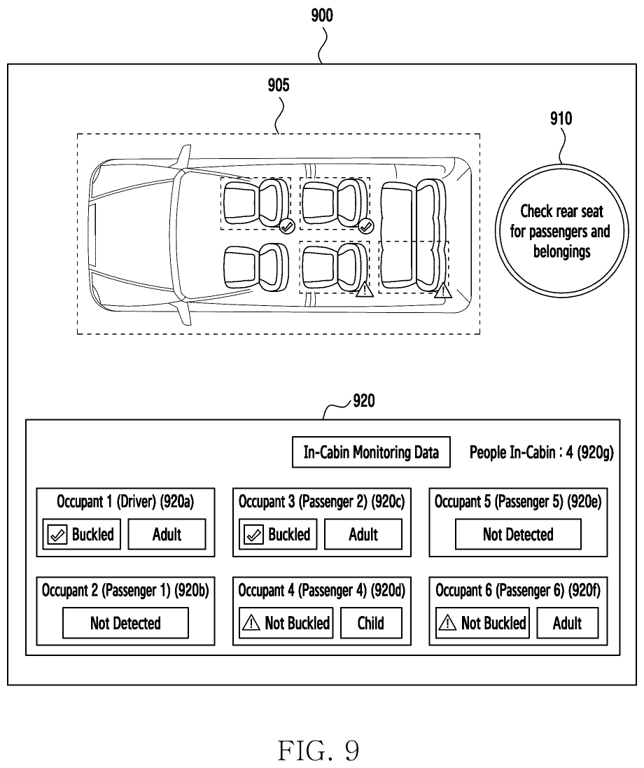

FIG. 9 illustrates an example of information displayed on a display 900 of a vehicle (e.g., the vehicle 110 of FIG. 1), according to an embodiment. The display 900 of FIG. 9 may be disposed on a dashboard of the vehicle. The display 900 may be included in the electronic device 101 or may be electrically connected to the electronic device 101, according to an embodiment.

FIG. 9 illustrates an operation of displaying information for passenger monitoring through a display 900 of an electronic device disposed in a vehicle (e.g., the power circuit 101 of FIG. 1), according to an embodiment. For example, the electronic device mounted on the vehicle may visualize in-vehicle monitoring information through the display 900.

Referring to FIG. 9, it is illustrated an example of visual objects (905, 910, 920) displayed on the display 900 by the electronic device mounted on the vehicle. The visual objects (905, 910, 920) may be displayed through a user interface (UI) that may be referred to as a notification center (or a notification panel) provided in an operating system of the vehicle.

The electronic device installed in the vehicle may visually display, through the visual object 905, information about an image of the vehicle subject to the in-cabin monitoring system (ICMS), seats installed in the vehicle, whether an occupant is detected in the corresponding seats, and/or whether the occupant on the corresponding seat wears a seat belt. Upon detecting an occupant from at least one of the seats, the electronic device may display an icon, image, and/or text indicating whether the occupant corresponds to an adult or a child.

The electronic device installed in the vehicle may visually display information indicating that there is an object (e.g., a passenger and/or personal belongings) detected in the rear seats of the vehicle, after the driver turns off the vehicle or before getting off the vehicle, using the visual object 910.

The electronic device installed in the vehicle may visually display ICMS data via the visual object 920. Specifically, the visual object 920a may represent monitoring information (e.g., safety belt buckled, adult) about an occupant 1 (driver) of the vehicle. The electronic device may indicate that a certain seat is not occupied, using the visual object 920b. The electronic device may display monitoring information (e.g., safety belt buckled, adult) (e.g., ICMS data) about an occupant 3 (passenger 2) of the vehicle, using the visual object 920c. The electronic device may display a visual object 920d representing monitoring information (e.g., wearing no safety belt, child) about an occupant 4 (passenger 3) of the vehicle. The electronic device may display monitoring information (not detected) (no occupant) about an occupant 5 (passenger 5) of the vehicle, using the visual object 920e. The visual object 920f may indicate monitoring information (safety belt not buckled, adult) about an occupant 6 (passenger 6) of the vehicle. These visual objects (920a, 920b, 920c, 920d, 920e, 920f) may indicate a result of detecting an occupant or passenger in each of seats (e.g., six seats in an embodiment of FIG. 9) of the vehicle.

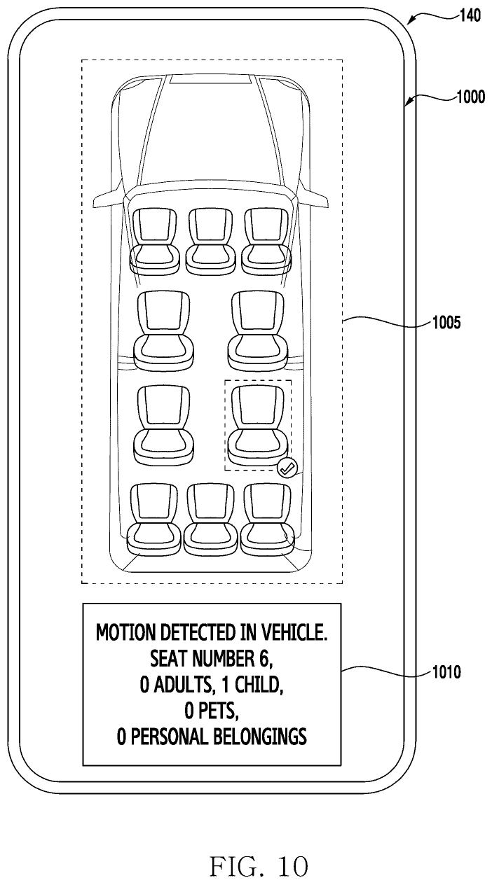

FIG. 10 illustrates an example of a screen displayed on the display 1000 of the user terminal 140 according to a signal transmitted from an electronic device (e.g., the electronic device 101 of FIG. 1), according to an embodiment. The operation of the electronic device described with reference to FIG. 10 may be performed by the electronic device 101 of FIG. 1 and/or the processor 210 of FIG. 2. FIG. 10 illustrates exemplary messages displayed on a display 1000 of a user terminal by a signal transmitted from an electronic device, according to an embodiment.

Referring to FIG. 10, it is illustrated an example state in which the electronic device 101 and/or the server 130 performing the operations described above with reference to FIGS. 1 to 3 transmits a notification message to the user terminal 140. The user terminal 140 may visualize the notification message received from the electronic device 101 and/or the server 130 on the display 1000.

In one embodiment, the visual objects 1005 and 1010 may be visualized in the form of bubbles for distinguishing messages managed by a messenger application, within a UI provided by the messenger application. Embodiment are not limited thereto, and the screen displayed on the display 1000 of FIG. 10 may be displayed by a smart-car application installed in the user terminal 140 to execute a vehicle-related function.

By using the visual object 1005, the user terminal 140 may visualize an image of a bus with the electronic device being installed therein, the seats installed in that bus, whether an occupant is detected in the corresponding seats, information about whether the detected occupant is an adult or a child, information about whether the occupant on the corresponding seat wears a seat belt, or the like. For example, the user terminal 140 may display the visual object 905 including at least one figure, text, image, and/or icon superimposed on an image representing the vehicle, using information transmitted from an electronic device and/or a server in the vehicle.

Referring to FIG. 10, as in a visual object 1010, the electronic device 101 and/or server 130 may send a notification message to the user terminal 140, that includes a natural language sentence with text to specify the information detected inside the vehicle (e.g., “Motion detected in vehicle: seat number 6, 0 adults, 1 child, 0 pets, 0 personal belongings”). Upon receiving the notification message, the user terminal 140 may display the visual object 1010 including a natural language sentence included in the notification message, on the display 1000.

While it is illustrated an example of the user terminal 140 displaying the visual objects 1005 and 1010 related to the vehicle, embodiments are not limited thereto. For example, together with at least one of the visual objects 1005 and 1010, the user terminal 410 may further display one or more visual objects having a button shape to (remotely) control the vehicle.

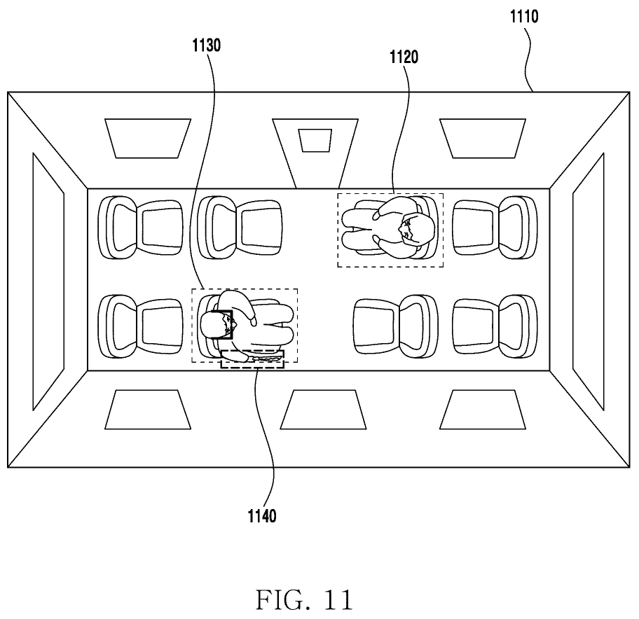

FIG. 11 illustrates an example of information related to at least one occupant in a vehicle (e.g., the vehicle 110 of FIG. 1) including an electronic device, detected by the electronic device (e.g., the electronic device 101 of FIG. 1), according to an embodiment. FIG. 11 illustrates displaying passenger monitoring information through a display of an electronic device disposed in a vehicle, according to an embodiment.

According to an embodiment, when a vehicle operates in a fully autonomous driving mode, the public transportation such as e.g., bus, train, subway, or the like may transport only passengers without a driver on board. In such a circumstance, there may be increasing needs for the entities operating the public transportation vehicles to remotely monitor the safety management of their vehicles and to detect and prevent situations that may pose a safety threat to passengers and/or vehicles.

Thus, as shown in FIG. 11, an electronic device of an entity operating a public transportation vehicle may, based on the behavior of the occupants identified through an ICMS installed on the public transportation vehicles (e.g., bus), the belongings of the occupants, and the like, predict a possible occurrence of a situation that may threaten the safety of the transportation vehicle, remotely control to stop the operation of the transportation vehicle, and/or send a dispatch request to a security-related agency (e.g., police, security company, or the like).

Referring to FIG. 11, an example of an image 1110 transmitted from the electronic device included in the vehicle to an external server (e.g., a server for managing public transportation vehicles) is illustrated. The image 1110 may be obtained from one or more cameras included in the vehicle by the electronic device. Along with the image 1110, the electronic device may transmit to the external server information indicating a result of detecting an external object (e.g., a passenger) in the vehicle, using the image 1110. Referring to FIG. 11, illustrated are bounding boxes (1120, 1130, 1140) representing areas corresponding to one or more numerical values included in the information and corresponding to an external object in an image 1110. For example, together with the image 1110, the electronic device may transmit, in the image 1110, information (e.g., metadata of the image 1110) including coordinates of vertices of the area corresponding to the external object. Along with the coordinates, the electronic device may transmit information indicating the type and/or category of the external object corresponding to the area.

Referring to FIG. 11, the electronic device may detect a plurality of passengers and one or more objects, from the image 1110 obtained from the cameras disposed toward inside of the vehicle. The bounding box 1120 may correspond to a first passenger detected by the electronic device. For example, the bounding box 1120 may indicate a position of the first passenger in the vehicle and/or a position related to the first passenger in the image 1110. The bounding box 1130 may correspond to a second passenger who has been detected by the electronic device and boarding the vehicle.

In one embodiment, the electronic device may detect an object as well as a passenger within the vehicle in the image 1110, using an object detection (OD). For example, the electronic device may detect an object that may cause an accident, such as e.g., a knife and/or a gun, from the image 1110. In an embodiment of FIG. 11, the electronic device may transmit information related to the bounding box 1140 to an external server to show a result of detecting any dangerous object such as a knife. In an embodiment, the electronic device detecting the dangerous object, using a portion of the image 1110 corresponding to the bounding box 1140, may transmit a signal indicating that the dangerous object has been detected, to an external server and/or a user terminal related to the vehicle. In an embodiment, the electronic device may predict behavior of the passengers of the vehicle in the image 1110 using the OD. For example, the electronic device may detect, from the image 1110, any violence-promoting behavior, such as e.g., smoking, drinking, and the like of the passengers of the vehicle. In an embodiment of FIG. 11, upon detecting such a dangerous behavior that may threaten the safety of the vehicle and other passengers, using the behavior information of the passengers detected from the image 1110, the electronic device may transmit a signal indicating that occurrence of a dangerous behavior in the vehicle has been detected, to an external server and/or a user terminal related to the vehicle.

In an embodiment, a solution for quickly detecting a living organism (e.g., a person and/or a pet) trapped in a vehicle may be required. As described above, according to an embodiment, an electronic device (e.g., the electronic device 101 of FIG. 1) mountable on a vehicle (e.g., the vehicle 110 of FIG. 1) may include a port (e.g., the port 228 of FIG. 2), a communication circuit (e.g., the communication circuit 212 of FIG. 2), memory storing instructions, and a processor (e.g., the processor 210 of FIG. 2). The instructions, when executed by the processor, may cause the electronic device to detect states of doors of the vehicle, based on interruption of power received from a battery of the vehicle. The instructions, when executed by the processor, may cause the electronic device to, in response to detecting the states corresponding to a closed state, receive sensor data of a plurality of sensors (e.g., the plurality of sensors 120 of FIG. 1) disposed inside of the vehicle, through the port. The instructions, when executed by the processor, may cause the electronic device to, in response to detecting motion within the vehicle by using the sensor data, transmit a signal to provide an alarm associated with the motion to an external electronic device (e.g., the server 130 and/or the user terminal 140 of FIG. 1) through the communication circuit. According to an embodiment, the electronic device may detect motion, using the sensors distributed in the vehicle, while all of the doors of the vehicle are locked.

For example, the electronic device may comprise a camera disposed toward the front direction of the vehicle. The instructions, when executed by the processor, may cause the electronic device to receive the sensor data through the port connectable to a camera disposed to face a rear direction of the vehicle.

For example, the instructions, when executed by the processor, may cause the electronic device to obtain the sensor data of each of the plurality of sensors from an integrated electrical signal in which electrical signals of the plurality of sensors are multiplexed, which is received through a multiplexing device connected to the port.

For example, the instructions, when executed by the processor, may cause the electronic device to receive the sensor data including video within the vehicle from the plurality of sensors which are cameras. The instructions, when executed by the processor, may cause the electronic device to perform object detection with respect to the video, by using a neural network to which the video is input.

For example, the instructions, when executed by the processor, may cause the electronic device to transmit the signal to the external electronic device through the communication circuit, in response to detecting an external object different from the vehicle from the video using the object recognition.

For example, the instructions, when executed by the processor, may cause the electronic device to, in response to receiving another signal including a request associated with a streaming of the video from the external electronic device, establish a communication link between the external electronic device and the electronic device, using the communication circuit. The instructions, when executed by the processor, may cause the electronic device to provide the video received from the plurality of sensors, to the external electronic device through the communication link.

For example, the instructions, when executed by the processor, may cause the electronic device to transmit the signal, to the external electronic device through the communication circuit, to provide the alarm including a hyperlink to establish the communication link and a text message associated with the alarm.

For example, the instructions, when executed by the processor, may cause the electronic device to detect an external object moving in the vehicle, by using the sensor data received from the plurality of sensors that are radars.

For example, the electronic device may comprise a carbon-dioxide sensor configured to parametrize a numeric value associated with carbon-dioxide included in air within the vehicle. The instructions may, when executed by the processor, cause the electronic device to, in response to detecting the states corresponding to the closed state, detect a living organism synthesizing the carbon-dioxide within the vehicle, using the numeric value parametrized by the carbon-dioxide sensor.

For example, the electronic device may comprise an antenna associated with an ultra-wideband (UWB). The instructions may, when executed by the processor, cause the electronic device to, when executed by the processor, cause the electronic device to, in response to detecting the states corresponding to the closed state, detect a wireless signal by controlling the antenna, the wireless signal being transmitted from a remote controller corresponding to the vehicle and included in the UWB. The instructions may, when executed by the processor, cause the electronic device to, when executed by the processor, cause the electronic device to, using a location of the remote controller with respect to the vehicle that is computed by the wireless signal detected using the antenna, determine whether to detect the motion by using the sensor data.

For example, the instructions, when executed by the processor, may cause the electronic device to perform detect of the motion, using the sensor data, for a preset duration from a time point at which the states corresponding to the closed state are detected.

For example, the instructions, when executed by the processor, may cause the electronic device to, in response to detecting the motion using the sensor data, blow a horn of the vehicle or activate a light emitting component of the vehicle.

As described above, according to an embodiment, a method of an electronic device comprising a port and a communication circuit and mountable on a vehicle may be provided. The method may comprise detecting states of doors of the vehicle, based on interruption of power which was received from a battery of the vehicle. The method may comprise, in response to detecting the states corresponding to a closed state, receiving sensor data of a plurality of sensors disposed inside of the vehicle, through the port. The method may comprise, in response to detecting motion within the vehicle by using the sensor data, transmitting a signal to provide an alarm associated with the motion to an external electronic device through the communication circuit.

For example, the receiving may comprise receiving the sensor data through the port that is connectable with a camera disposed toward a rear direction of the vehicle.

For example, the receiving may comprise obtaining the sensor data of each of the plurality of sensors from an integrated electronic signal, that is received through a multiplexing device connected to the port, where electronic signals of the plurality of sensors are multiplexed.

For example, the receiving may comprise receiving the sensor data including video within the vehicle from the plurality of sensors that are cameras. The transmitting may comprise performing object recognition with respect to the video by using a neural network to which the video is input.

For example, the transmitting may comprise, in response to detecting an external object different from the vehicle from the video by using the object detection, transmitting the signal to the external electronic device through the communication circuit.

For example, the method may comprise, in response to receiving another signal including a request associated with a streaming of the video from the external electronic device, establishing a communication link between the external electronic device and the electronic device by using the communication circuit. The method may comprise providing the video received from the plurality of sensors, to the external electronic device through the communication link.

For example, the transmitting may comprise transmitting the signal, to the external electronic device through the communication circuit, to provide the alarm including a hyperlink to establish the communication link and a text message associated with the alarm.

As described above, according to an embodiment, a non-transitory computer-readable storage medium including instructions may be provided. The instructions, when executed by a processor of an electronic device including a port and a communication circuit, and mountable on a vehicle, may cause the electronic device to detect states of doors of the vehicle based on interruption of power which was received from a battery of the vehicle. The instructions, when executed by the processor, may cause the electronic device to, in response to detecting the states corresponding to a closed state, receive sensor data of a plurality of sensors disposed inside of the vehicle through the port. The instructions, when executed by the processor, may cause the electronic device to, in response to detecting motion within the vehicle by using the sensor data, transmit a signal to provide an alarm associated with the motion to an external electronic device through the communication circuit.

The above-described device may be implemented as hardware components, software components, and/or a combination of hardware components and software components. For example, the devices and components described in the embodiments may be implemented using one or more general-purpose computers or special-purpose computers, such as e.g., a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may perform an operating system (OS) and one or more software applications performed on the operating system. Further, the processing device may access, store, manipulate, process, and generate data in response to the execution of the software. For convenience of understanding, it may be described that one processing device is used. However, those skilled in the art may understand that the processing device may include a plurality of processing elements and/or a plurality of types of processing elements. For example, the processing device may include a plurality of processors or one processor and one controller. In addition, other processing configurations such as parallel processors are also possible.

The software may include a computer program, a code, an instruction, or one or more combinations thereof, and may configure a processing device to operate as desired or may independently or collectively instruct the processing device. Software and/or data may be interpreted by a processing device or may be embodied in any type of machine, component, physical device, computer storage medium, or device to provide a command or data to the processing device. Software may be distributed on a networked computer system and stored or executed in a distributed manner. Software and data may be stored in one or more computer-readable recording media.

The method according to an embodiment of the disclosure may be implemented in the form of program commands executable by various computer means and recorded on a computer-readable medium. In this case, the medium may be a persistent storage of a computer-executable program, or it may be a temporary storage for execution or download. Further, the medium may be various recording means or storage means in which a single piece of hardware or a plurality of pieces of hardware are combined, and the medium is not limited to a medium directly connected to a computer system, and may be distributed on a network. Examples of the medium may include a magnetic medium such as a hard disk, a floppy disk, and a magnetic tape, an optical recording medium such as a compact disc read only memory (CD-ROM) and a digital versatile disc (DVD), a magneto-optical medium such as a floptical disk, and a read only memory (ROM), a random access memory (RAM), a flash memory, etc. configured to store program instructions. In addition, examples of other media include recording media or storage media managed by an application store that distributes applications, a site that supplies or distributes various other software, a server, and the like.

As described above, although the embodiments have been described with reference to limited embodiments and drawings, various modifications and modifications may be made from the above description by those skilled in the art. For example, even if the described techniques are performed in a different order from the described method, and/or components such as the described system, structure, device, circuit, etc. are combined or combined in a different form from the described method, or are replaced or substituted by other components or equivalents, appropriate results may be achieved.

Therefore, other implementations, other embodiments, and those equivalent to the scope of the patent claim also fall within the scope of the patent claims to be described later.

What is claimed is:

1. An electronic device mountable on a vehicle, comprising:
a port;
a communication circuit;
memory storing instructions; and
a processor, wherein the instructions, when executed by the processor, cause the electronic device to:
detect states of doors of the vehicle based on interruption of power which was received from a battery of the vehicle;
in response to detecting the states corresponding to a closed state, receive sensor data of a plurality of sensors disposed inside of the vehicle, through the port;
in response to detecting motion within the vehicle by using the sensor data, transmit a signal to provide an alarm associated with the motion to an external electronic device through the communication circuit.

2. The electronic device of claim 1, further comprising a camera disposed toward a front direction of the vehicle,
wherein the instructions, when executed by the processor, cause the electronic device to receive the sensor data through the port that is connectable with a camera disposed toward a rear direction of the vehicle.

3. The electronic device of claim 1, wherein the instructions, when executed by the processor, cause the electronic device to:
obtain the sensor data of each of the plurality of sensors from an integrated electronic signal, that is received through a multiplexing device connected to the port, where electronic signals of the plurality of sensors are multiplexed.

4. The electronic device of claim 1, wherein the instructions, when executed by the processor, cause the electronic device to:
receive the sensor data including video within the vehicle from the plurality of sensors which are cameras; and
by using a neural network to which the video is inputted, perform object detection with respect to the video.

5. The electronic device of claim 4, wherein the instructions, when executed by the processor, cause the electronic device to:
in response to detecting an external object different from the vehicle from the video by using the object detection, transmit the signal to the external electronic device through the communication circuit;

6. The electronic device of claim 4, wherein the instructions, when executed by the processor, cause the electronic device to:
in response to receiving another signal including a request associated with a streaming of the video from the external electronic device, establish a communication link between the external electronic device and the electronic device by using the communication circuit; and
provide the video received from the plurality of sensors, to the external electronic device through the communication link.

7. The electronic device of claim 6, wherein the instructions, when executed by the processor, cause the electronic device to:
transmit the signal to the external electronic device through the communication circuit, to provide the alarm including a hyperlink to establish the communication link and a text message associated with the alarm.

8. The electronic device of claim 1, wherein the instructions, when executed by the processor, cause the electronic device to:
by using the sensor data received from the plurality of sensors which are radars, detect an external object being moved in the vehicle.

9. The electronic device of claim 1, further comprising a carbon-dioxide sensor configured to parametrize a numeric value associated with carbon-dioxide included in air within the vehicle,
wherein the instructions, when executed by the processor, cause the electronic device to:
in response to detecting the states corresponding to the closed state, detect a living organism synthesizing the carbon-dioxide within the vehicle by using the numeric value parametrized by the carbon-dioxide sensor.

10. The electronic device of claim 1, further comprising an antenna associated with ultra-wideband (UWB);
wherein the instructions, when executed by the processor, cause the electronic device to:
in response to detecting the states corresponding to the closed state, detect a wireless signal by controlling the antenna, the wireless signal being transmitted from a remote controller corresponding to the vehicle and included in the UWB; and
by using a location of the remote controller with respect to the vehicle that is computed by the wireless signal detected by using the antenna, determine whether to detect the motion by using the sensor data.

11. The electronic device of claim 1, wherein the instructions, when executed by the processor, cause the electronic device to:
for a preset duration from a moment when the states corresponding to the closed state are detected, perform detection of the motion by using the sensor data.

12. The electronic device of claim 1, wherein the instructions, when executed by the processor, cause the electronic device to:
in response to detecting the motion by using the sensor data, blow a horn of the vehicle or activate a light emitting component of the vehicle.

13. A method of an electronic device including a port and a communication circuit and mountable on a vehicle, comprising:
detecting states of doors of the vehicle based on interruption of power which was received from a battery of the vehicle;
in response to detecting the states corresponding to a closed state, receiving sensor data of a plurality of sensors disposed inside of the vehicle, through the port; and
in response to detecting motion within the vehicle by using the sensor data, transmitting a signal to provide an alarm associated with the motion to an external electronic device through the communication circuit.

14. The method of claim 13, wherein the receiving comprises:
receiving the sensor data through the port that is connectable with a camera disposed toward a rear direction of the vehicle.

15. The method of claim 13, wherein the receiving comprises:
obtaining the sensor data of each of the plurality of sensors from an integrated electronic signal, that is received through a multiplexing device connected to the port, where electronic signals of the plurality of sensors are multiplexed.

16. The method of claim 13,
wherein the receiving comprises:
receiving the sensor data including video within the vehicle from the plurality of sensors which are cameras; and
wherein the transmitting comprises:
by using a neural network to which the video is inputted, performing object detection with respect to the video.

17. The method of claim 16, wherein the transmitting comprises:
in response to detecting an external object different from the vehicle from the video by using the object detection, transmitting the signal to the external electronic device through the communication circuit;

18. The method of claim 16, further comprising:
in response to receiving another signal including a request associated with a streaming of the video from the external electronic device, establishing a communication link between the external electronic device and the electronic device by using the communication circuit; and
providing the video received from the plurality of sensors, to the external electronic device through the communication link.

19. The method of claim 18, wherein the transmitting comprises:
transmitting the signal to the external electronic device through the communication circuit, to provide the alarm including a hyperlink to establish the communication link and a text message associated with the alarm.

20. A non-transitory computer readable storage medium including instructions, wherein the instructions, when executed by a processor of an electronic device including a port and a communication circuit, and mountable on a vehicle, cause the electronic device to:
detect states of doors of the vehicle based on interruption of power which was received from a battery of the vehicle;
in response to detecting the states corresponding to a closed state, receive sensor data of a plurality of sensors disposed inside of the vehicle through the port; and
in response to detecting motion within the vehicle by using the sensor data, transmit a signal to provide an alarm associated with the motion to an external electronic device through the communication circuit.
